(19) United States
(12) Patent Application Publication
(10) Pub. No.: US 2012/0033150 A1
(43) Pub. Date: Feb. 9, 2012

(54) LIQUID CRYSTAL DISPLAY PANEL AND METHOD OF FABRICATING THE SAME

(75) Inventors: Do-Hoon Kim, Yongin-city (KR); Dong-Gyu Kim, Yongin-city (KR); Warrick So, Yongin-city (KR)

(73) Assignee: Samsung Mobile Display Co., Ltd., Yongin-city (KR)

(21) Appl. No.: 13/069,818

(22) Filed: Mar. 23, 2011

(30) Foreign Application Priority Data
Aug. 9, 2010 (KR) 10-2010-0076632

(51) Int. Cl. G02F 1/1339; G02F 1/1335; B32B 37/14; G02F 1/136

(52) U.S. Cl. 349/43; 349/153; 349/106; 156/145

(57) ABSTRACT

A liquid crystal display panel and a method of fabricating the same are disclosed. In one embodiment, the liquid crystal display panel includes i) a first substrate and a second substrate facing each other, ii) a liquid crystal layer disposed between the first and second substrates, iii) a color filter disposed between the liquid crystal layer and the second substrate and iv) a black matrix formed on the color filter. The panel may further include i) a sealing member disposed on an outer portion of the liquid crystal layer between the first and second substrates so as to couple the two substrates to each other ii) a plurality of protrusion members formed on the second substrate so as to at least partially overlap with the sealing member iii) a reflective layer formed on the protrusion members and iv) a cover layer formed on the reflective layer so as to cover the reflective layer and the protrusion members.

### CROSS-REFERENCE TO RELATED PATENT APPLICATION

This application claims the benefit of Korean Patent Application No. 10-2010-0076632, filed on Aug. 9, 2010, in the Korean Intellectual Property Office, the disclosure of which is incorporated herein in its entirety by reference.

### BACKGROUND

1. Field

The described technology generally relates to a liquid crystal display panel and a method of fabricating the display panel, and more particularly, to a liquid crystal display panel and a method of fabricating the display panel, which may improve a durability of the liquid crystal display panel easily.

2. Description of the Related Technology

Recently, display panels have been substituted by thin flat display panels that are portable. Among the flat panel displays, liquid crystal display panels have low power consumption and generate little electromagnetic waves, and thus, are considered as next generation display panels.

A liquid crystal display panel is fabricated by injecting liquid crystal between two substrates and combining the two substrates to each other by using a sealing member. The sealing member is hardened by a light source such as ultraviolet radiation; however, it is not easy to uniformly harden the sealing member. Thus, a coupling property between the two substrates may be degraded, and consequently, there is a limitation in improving a durability of the liquid crystal display panel.

### SUMMARY

One inventive aspect is a liquid crystal display panel and a method of fabricating the liquid crystal display panel, which may improve a durability of the liquid crystal display panel easily.

Another aspect is a liquid crystal display panel including: a first substrate and a second substrate facing each other; a liquid crystal layer disposed between the first substrate and the second substrate; a color filter disposed between the liquid crystal layer and the second substrate; a black matrix formed on the color filter; a sealing member disposed on an outer portion of the liquid crystal layer between the first substrate and the second substrate so as to couple the first substrate and the second substrate to each other; a plurality of protrusion members formed on the second substrate so as to overlap the sealing member; a reflective layer formed on the plurality of protrusion members; and a cover layer formed on the reflective layer so as to cover the reflective layer and the plurality of protrusion members.

The liquid crystal display panel may further include a wiring portion formed between the sealing member and the first substrate.

The liquid crystal display panel may further include: a thin film transistor disposed between the first substrate and the liquid crystal layer so as to be electrically connected to the wiring portion, and comprising a gate electrode, an active layer, a source electrode, and a drain electrode.

The cover layer may fill spaces between the plurality of protrusion members.

The cover layer may be formed between the sealing member and the reflective layer.

A surface of the cover layer, which contacts the sealing member, may be formed flat.

The liquid crystal display panel may further include a buffer portion between the second substrate and the color filter.

The buffer portion may be formed on the second substrate so as to be separated from the protrusion members.

The buffer portion may be formed of the same material as that of the protrusion members.

The buffer portion may include one or more via holes, and the color filter may be formed to fill the via holes.

The reflective layer may be formed of the same material as that of the black matrix.

The liquid crystal display panel may further include a spacer disposed between the first substrate and the second substrate so as to maintain a space in which the liquid crystal layer is disposed, and the cover layer may be formed of the same material as that of the spacer.

The cover layer may be elongated so as to cover the color filter and the black matrix.

The cover layer may be formed of the same material as that of the color filter.

Another aspect is a method of fabricating a liquid crystal display panel, the method including: preparing a first substrate and a second substrate which face each other; disposing a liquid crystal layer between the first substrate and the second substrate; disposing a black matrix between the liquid crystal layer and the second substrate; disposing a color filter on the black matrix; disposing a sealing member on an outer portion of the liquid crystal layer between the first substrate and the second substrate; forming a plurality of protrusion members on the second substrate so as to overlap the sealing member; forming a reflective layer on the protrusion members; forming a cover layer on the reflective layer so as to cover the reflective layer and the protrusion members; and irradiating ultraviolet (UV) radiation onto the sealing member so as to couple the first substrate and the second substrate to each other.

The method may further include forming a wiring portion between the sealing member and the first substrate.

The UV radiation may be irradiated from a side of the first substrate toward the second substrate.

The UV radiation transmitting through the sealing member may be reflected by the reflective layer.

### BRIEF DESCRIPTION OF THE DRAWINGS

FIG. 1 is a schematic cross-sectional view of a liquid crystal display panel according to an embodiment.

FIGS. 2A through 2E are cross-sectional views illustrating a method of fabricating the liquid crystal display panel of FIG. 1 according to an embodiment.

FIG. 3 is a schematic cross-sectional view of a liquid crystal display panel according to another embodiment.

FIGS. 4A through 4C are cross-sectional views illustrating a method of fabricating the liquid crystal display panel of FIG. 3 according to another embodiment.

FIG. 5 is a schematic cross-sectional view of a liquid crystal display panel according to another embodiment.

FIGS. 6A through 6D are cross-sectional views illustrating a method of fabricating the liquid crystal display panel of FIG. 5 according to another embodiment.

### DETAILED DESCRIPTION

Hereinafter, embodiments will be described in detail with reference to accompanying drawings.

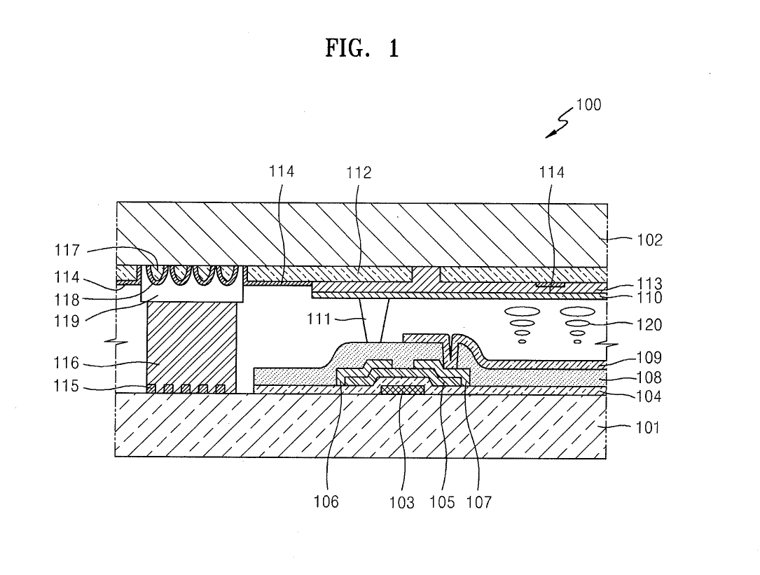

FIG. 1 is a schematic cross-sectional view of a liquid crystal display panel 100 according to an embodiment.

Referring to FIG. 1, the liquid crystal display panel 100 includes a first substrate 101, a second substrate 102, a liquid crystal layer 120, a color filter 113, a black matrix 114, a sealing member 116, a protrusion member 117, a reflective layer 118, and a cover layer 119. For the convenience of explanation, FIG. 1 shows a partial cross-section of the liquid crystal display panel 100.

The first and second substrates 101 and 102 are disposed to face each other, and the liquid crystal layer 120 is disposed between the two substrates 101 and 102. The sealing member 116 is disposed on an outer portion of the liquid crystal layer 120. On the first substrate 101, a thin film transistor that is electrically connected to the liquid crystal layer 120 is formed, and the thin film transistor includes a gate electrode 103, an active layer 105, a source electrode 106, and a drain electrode 107.

In one embodiment, the first substrate 101 is formed of a transparent material. For example, the first substrate 101 may be formed of a transparent glass material including SiO₂ or a transparent plastic material.

The gate electrode 103 is formed on the first substrate 101 in a predetermined pattern. A gate insulating layer 104 is formed on the gate electrode 103, and the active layer 105 is formed on the gate insulating layer 104 in a predetermined pattern. The source electrode 106 and the drain electrode 107 are formed on the active layer 105. Although not shown in FIG. 1, an ohmic contact layer may be further formed between the active layer 105 and the source electrode 106 and the active layer 105 and the drain electrode 107.

In addition, a passivation layer 108 is formed to cover the source electrode 106 and the drain electrode 107. Here, the passivation layer 108 is etched to expose the source electrode 106 or the drain electrode 107, and a first electrode 109 is formed in a predetermined pattern so as to be electrically connected to the exposed source or drain electrode 106 or 107.

The second substrate 102 faces the first substrate 101. In one embodiment, the second substrate 102 is also formed of a transparent material, like the first substrate 101. The active layer 120 is disposed between the first and second substrates 101 and 102. Although not shown in FIG. 1, an orientation layer may be disposed for orientation of the liquid crystal layer 120.

A buffer portion 112 may be formed on the second substrate 102. The buffer portion 112 may be formed of various organic materials. The buffer portion 112 provides a flat surface on a lower portion of the second substrate 102 so that a surface of the color filter 113 may be uniformed. In addition, the buffer portion 112 buffs stress applied to the liquid crystal display panel 100 so as to improve a durability of the liquid crystal display panel 100.

The black matrix 114 is formed on the buffer portion 112 in a predetermined pattern. The black matrix 114 prevents visible radiation realized by the color filter 113 from mixing with each other and interfering with each other.

The color filter 113 is formed on the black matrix 114. The color filter 113 is also located on the buffer portion 112. In one embodiment, one or more via holes are formed in the buffer portion 112, and the color filter 113 is formed to fill the via holes. Thus, a height of the color filter 113 may be controlled, and a coupling force between the color filter 113 and the second substrate 102 may be improved.

A second electrode 110 is formed on a lower surface of the color filter 113, and the liquid crystal layer 120 is formed between the first electrode 109 and the second electrode 110.

A spacer 111 is disposed between the first and second electrodes 109 and 110. The spacer 111 maintains a space in which the liquid crystal layer 120 is disposed.

The sealing member 116 is disposed on the outer portion of the liquid crystal layer 120 so as to couple the first and second substrates 101 and 102 to each other. The sealing member 116 may be an ultraviolet (UV)-curable resin.

A plurality of protrusion members 117 are disposed to at least partially overlap with the sealing member 116. In one embodiment, the protrusion members 117 are formed on the second substrate 102. In this embodiment, the protrusion members 117 are formed on the same layer as the buffer portion 112, and may include the same material as the buffer portion 112. The plurality of protrusion members 117 are formed to be separated from each other.

The reflective layer 118 is formed on the protrusion members 117. The reflective layer 118 is formed to cover surfaces of the protrusion members 117. The reflective layer 118 includes metal, for example, the same material as that included in the black matrix 114.

The cover layer 119 is formed on the reflective layer 118. The cover layer 119 is formed to contact the sealing member 116. The cover layer 119 is formed to fill spaces between the protrusion members 117. The cover layer 119 prevents the protrusion members 117 and reflective layer 118 from being damaged.

In one embodiment, a surface of the cover layer 119, which contacts the sealing member 116, is formed substantially flat to improve coupling force between the cover layer 119 and the sealing member 116.

The cover layer 119 may be formed of various materials, for example, the same material as that forming the spacer 111.

A wiring portion 115 is formed on the first substrate 101 to contact the sealing member 116. The wiring portion 115 includes a plurality of wires that are separated from each other. Although not shown in FIG. 1, the wiring portion 115 is electrically connected to electrodes of the thin film transistor, that is, the gate electrode 103, the source electrode 106, or the drain electrode 107.

FIG. 1 shows a thin film transistor (TFT)-liquid crystal display (LCD) as an example; however, the liquid crystal panel 100 is not limited thereto. Operations of the liquid crystal display panel 100 will be described as follows. A potential difference is generated between the first and second electrodes 109 and 110 by an external signal controlled by the gate electrode 103, the source electrode 106, and the drain electrode 107, and an arrangement of the liquid crystal layer 120 is determined by the potential difference. In addition, visible radiation supplied from an additional backlight that is installed on an outer portion of the liquid crystal display panel 100 is shielded or transmitted through the liquid crystal display panel 100 according to the arrangement of the liquid crystal layer 120. When the light transmits through the color filter 13, color images are realized.

The liquid crystal display panel 100 includes the sealing member 116, and the sealing member 116 includes a resin that is cured by the light such as UV radiation. During fabricating the liquid crystal display panel 100, the UV radiation is incident from a side of the first substrate 101 to cure the sealing member 116, and then, the UV ray is partially blocked due to the wiring portion 115. Thus, the UV ray may not be evenly incident onto the sealing member 116. In particular, a part of the sealing member 116, which is adjacent to the wiring portion 115, may be less cured than other parts of the sealing member 116.

However, the liquid crystal display panel 100 includes the protrusion members 117. In addition, the reflective layer 118 is formed on the protrusion members 117. The UV ray transmitting through the sealing member 116 among the UV radiation incident through the first substrate 101 is reflected by the reflective layer 118 toward the first substrate 101. Therefore, the UV radiation may effectively reach the part of the sealing member 116, which is adjacent to the wiring portion 115, and thus, the entire part of the sealing member 116 may be evenly cured.

Consequently, durability of the sealing member 116, and thereby improving durability of the liquid crystal display panel 100.

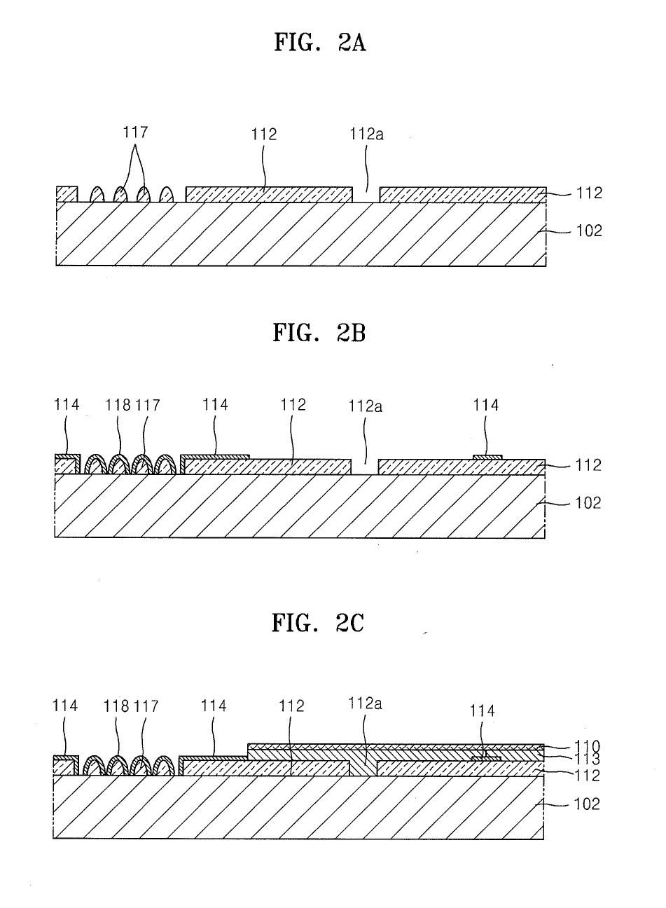

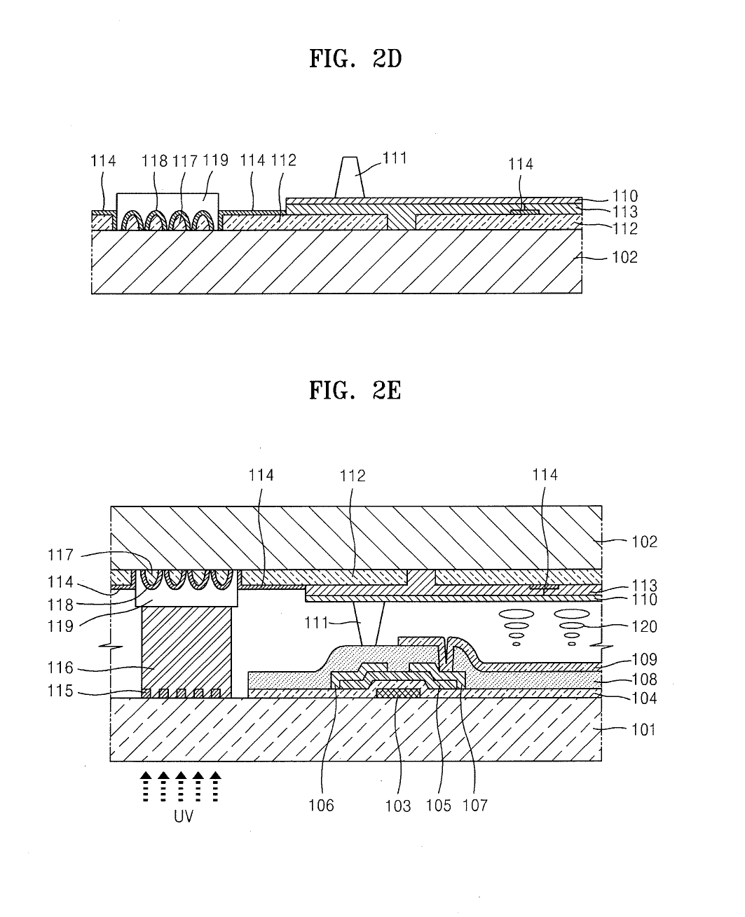

FIGS. 2A through 2E are cross-sectional views illustrating a method of fabricating the liquid crystal display panel 100 of FIG. 1 according to an embodiment.

Referring to FIG. 2A, the buffer portion 112 and the protrusion members 117 are formed on the second substrate 102. The buffer portion 112 and the protrusion members 117 may be substantially simultaneously patterned by using an organic material. The buffer portion 112 includes one or more via holes 112a.

Referring to FIG. 2B, the black matrix 114 and the reflective layer 118 are formed. The black matrix 114 is formed on the buffer portion 112 in a predetermined pattern. The reflective layer 118 is formed on the protrusion members 117. The reflective layer 118 may be formed of the same material as that of the black matrix 114 substantially simultaneously with the black matrix 114.

After that, referring to FIG. 2C, the color filter 113 and the second electrode 110 are formed. The color filter 113 is formed on the black matrix 114, and is formed to fill the via holes 112a formed in the buffer portion 112. The second electrode 110 may include a transparent conductive material such as indium tin oxide (ITO).

Referring to FIG. 2D, the cover layer 119 and the spacer 111 are formed. The cover layer 119 is formed on the reflective layer 118, and is formed to fill the spaces between the protrusion members 117 and to have a flat surface. The spacer 111 is formed on the second electrode 110. The cover layer 119 and the spacer 111 may be formed of the same insulating material as each other.

Referring to FIG. 2E, the sealing member 116 is formed between the first and second substrates 101 and 102, and then, UV radiation is irradiated onto the sealing member 116. Then, the liquid crystal display panel 100 of FIG. 1 is fabricated. The UV radiation is irradiated from the side of the first substrate 101 toward the second substrate 102 to cure the sealing member 116. In addition, the UV radiation reaching the protrusion members 117 and the reflective layer 118 after transmitting through the sealing member 116 may be reflected toward the first substrate 101. Thus, the entire portion of the sealing member 116 may be evenly cured.

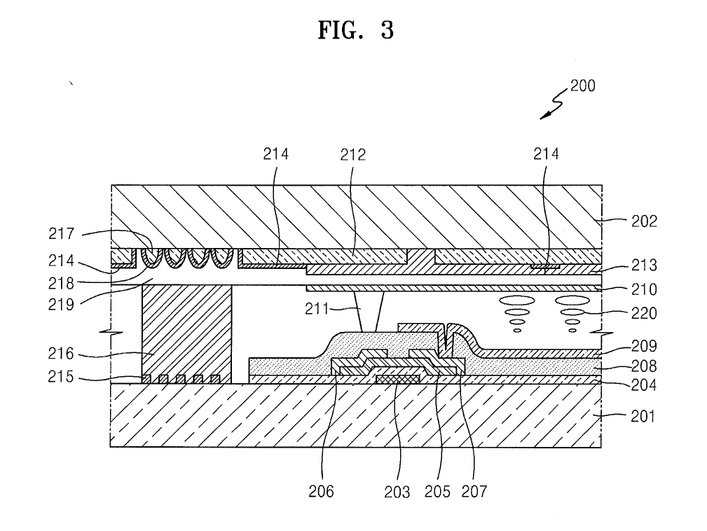

FIG. 3 is a schematic cross-sectional view of a liquid crystal display panel 200 according to another embodiment.

Referring to FIG. 3, the liquid crystal display panel 200 includes a first substrate 201, a second substrate 202, a liquid crystal layer 220, a color filter 213, a black matrix 214, a sealing member 116, a plurality of protrusion members 217, a reflective layer 218, and a cover layer 219. For the convenience of explanation, FIG. 3 shows a partial cross-section of the liquid crystal display panel 200.

The first and second substrates 201 and 202 are disposed to face each other, and the liquid crystal layer 220 is disposed between the first and second substrates 201 and 202. The sealing member 216 is disposed on an outer portion of the liquid crystal layer 220. In addition, a thin film transistor that is electrically connected to the liquid crystal layer 220 is formed on the first substrate 201, and the thin film transistor includes a gate electrode 203, an active layer 205, a source electrode 206, and a drain electrode 207.

The gate electrode 203 is formed on the first substrate 201 in a predetermined pattern. A gate insulating layer 204 is formed on the gate electrode 203, and the active layer 205 is formed on the gate insulating layer 204 in a predetermined pattern. The source and drain electrodes 206 and 207 are formed on the active layer 205.

A passivation layer 208 is formed to cover the source and drain electrodes 206 and 207. Here, the passivation layer 208 is etched to expose the source electrode 206 or the drain electrode 207, and then, a first electrode 209 is formed in a predetermined pattern to be electrically connected to the exposed electrode.

The second substrate 202 faces the first substrate 201. The liquid crystal layer 220 is disposed between the first and second substrates 201 and 202.

A buffer portion 212 is formed on the second substrate 202. The buffer portion 212 may be formed of various organic materials. The buffer portion 212 provides a flat surface on the lower portion of the second substrate 202 so that the color filter 213 has substantially an even surface. In addition, the buffer portion 212 buffs stress applied to the liquid crystal display panel 200 so as to improve durability of the liquid crystal display panel 200.

The black matrix 214 is formed on the buffer portion 212 in a predetermined pattern. The color filter 213 is formed on the black matrix 214. The color filter 213 is also located on the buffer portion 212. The buffer portion 212 includes one or more via holes, and the color filter 213 is formed to fill the via holes in the buffer portion 212. Therefore, a height of the color filter 213 may be adjusted, and a coupling force between the color filter 213 and the second substrate 202 may be improved.

The cover layer 219 is formed on a lower surface of the color filter 213, and a second electrode 210 is formed on a lower portion of the cover layer 219. In addition, the liquid crystal layer 220 is disposed between the first and second electrodes 209 and 210.

The spacer 211 is disposed between the first and second electrodes 209 and 210, and the spacer 211 maintains the space in which the liquid crystal layer 220 is disposed.

On the other hand, the sealing member 216 is disposed on the outer portion of the liquid crystal layer 220 so that the first and second substrates 201 and 202 are coupled to each other. The sealing member 216 may be a UV-curable resin.

In one embodiment, the protrusion members 217 are disposed so as to at least partially overlap with the sealing member 216. In this embodiment, the protrusion members 217 are formed on the second substrate 202. That is, the protrusion members 217 are formed on the same layer as that of the buffer portion 212, and may include the same material as that of the buffer portion 212. The protrusion members 217 are separated from each other.

The reflective layer 218 is formed on the protrusion members 217. The reflective layer 218 is formed to cover surfaces of the protrusion members 217. The reflective layer 218 includes a metal material, for example, the same material as that of the black matrix 214.

The cover layer 219 is also formed on the reflective layer 218. That is, the cover layer 219 is formed to be elongated so as to cover the reflective layer 218, the color filter 213, and the black matrix 214. The cover layer 219 contacts the sealing member 216. The cover layer 219 is formed to fill spaces between the protrusion members 217. The cover layer 219 prevents the protrusion members 217 and the cover layer 219 from being damaged.

In addition, the cover layer 219 prevents the color filter 213 and the black matrix 214 from being damaged, and the second electrode 210 from isolating from the cover layer 219.

In one embodiment, a surface of the cover layer 219, which contacts the sealing member 216, is formed substantially flat so as to improve the coupling force between the cover layer 219 and the sealing member 216.

The cover layer 219 may be formed of various insulating materials, for example, a resin.

A wiring portion 215 is formed on the first substrate 201 to contact the sealing member 216.

The liquid crystal display panel 200 includes the protrusion members 217. In addition, the reflective layer 218 is formed on the protrusion members 217. During fabricating the liquid crystal display panel 200, the UV radiation incident through the first substrate 201 for forming the sealing member 216 are reflected by the reflective layer 218 toward the first substrate 201. Thus, the UV radiation may effectively reach a part of the sealing member 216, which is adjacent to the wiring portion 215, and thus, entire portion of the sealing member 216 may be evenly cured.

Therefore, durability of the sealing member 216 is improved, and thereby improving the durability of the liquid crystal display panel 200.

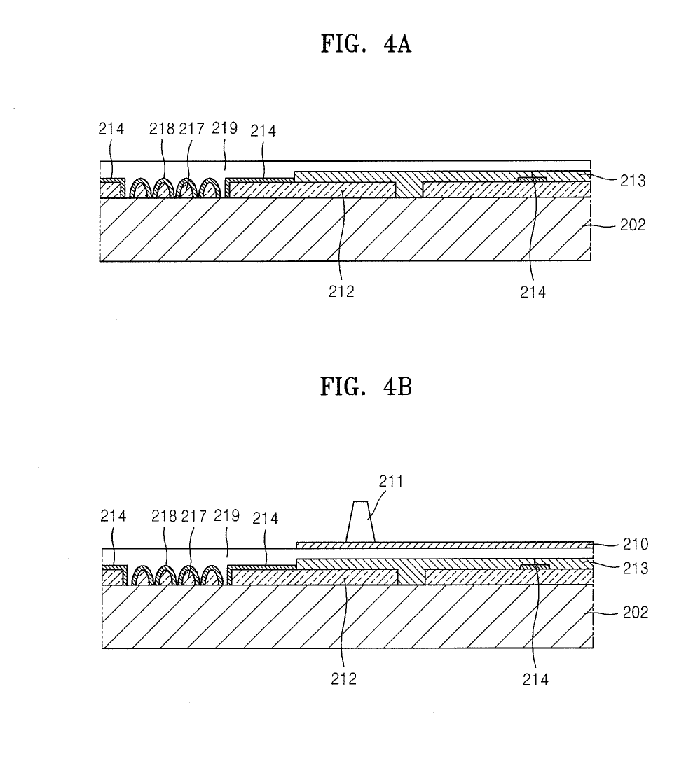

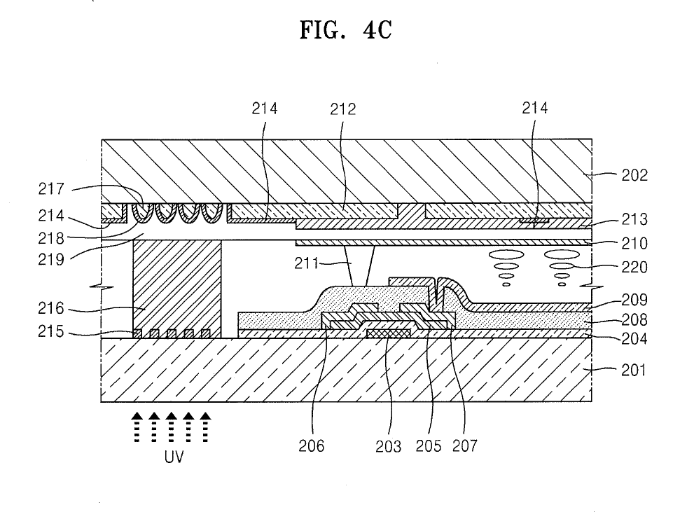

FIGS. 4A through 4C are cross-sectional views illustrating a method of fabricating the liquid crystal display panel 200 of FIG. 3 according to another embodiment. For the convenience of explanation, differences from the previous embodiment will be described.

Referring to FIG. 4A, the buffer portion 212, the protrusion members 217, the color filter 213, the black matrix 214, and the reflective layer 218 are formed on the second substrate 202, and then, the cover layer 219 is formed. The cover layer 219 is formed to cover the protrusion members 217, the color filter 213, and the black matrix 214. In addition, the cover layer 219 is formed to have a flat surface.

After that, as shown in FIG. 4B, the second electrode 210 and the spacer 211 are formed. The second electrode 210 is formed on the cover layer 219, and the spacer 211 is formed on the second electrode 210.

Referring to FIG. 4C, the sealing member 216 is formed between the first and second substrates 201 and 202, and the UV radiation is irradiated onto the sealing member 216. Then, the liquid crystal display panel 200 of FIG. 3 is fabricated. The UV radiation is irradiated from a side of the first substrate 201 toward the second substrate 202 to cure the sealing member 216. In addition, the UV radiation reaching the protrusion members 217 and the reflective layer 218 after transmitting through the sealing member 216 are reflected toward the first substrate 201. Then, the entire portion of the sealing member 216 may be substantially evenly cured.

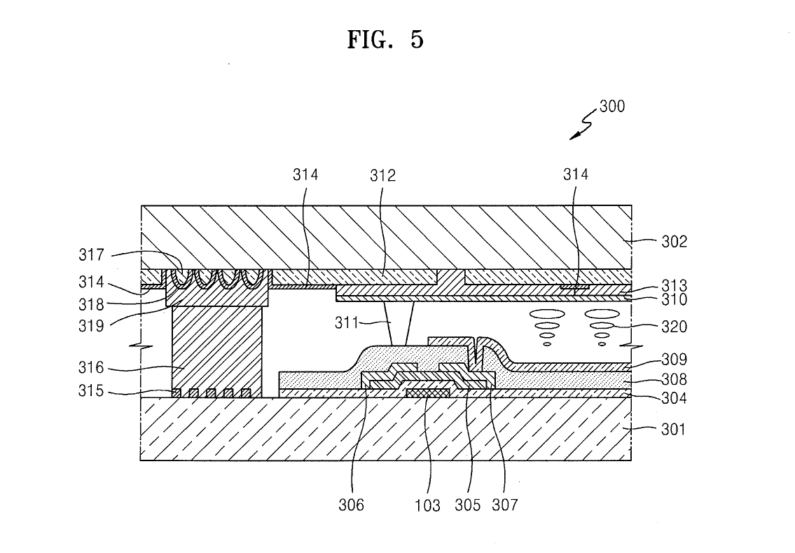

FIG. 5 is a schematic cross-sectional view of a liquid crystal display panel 300 according to another embodiment.

Referring to FIG. 5, the liquid crystal display panel 300 includes a first substrate 301, a second substrate 302, a liquid crystal layer 320, a color filter 313, a black matrix 314, a sealing member 316, a protrusion member 317, a reflective layer 318, and a cover layer 319. For the convenience of explanation, FIG. 5 shows a partial cross-section of the liquid crystal display panel 300.

The first and second substrates 301 and 302 are disposed to face each other, and the liquid crystal layer 320 is disposed between the first and second substrates 301 and 302. The sealing member 316 is disposed on an outer portion of the liquid crystal layer 320. In addition, a thin film transistor that is electrically connected to the liquid crystal layer 320 is formed on the first substrate 301, and the thin film transistor includes a gate electrode 303, an active layer 305, a source electrode 306, and a drain electrode 307.

The gate electrode 303 is formed on the first substrate 301 in a predetermined pattern. A gate insulating layer 304 is formed on the gate electrode 303, and the active layer 305 is formed on the gate insulating layer 304 in a predetermined pattern. The source and drain electrodes 306 and 307 are formed on the active layer 305.

In addition, a passivation layer 308 is formed to cover the source and drain electrodes 306 and 307. Here, the passivation layer 308 is etched to expose the source electrode 306 or the drain electrode 307, and then, a first electrode 309 is formed in a predetermined pattern to be electrically connected to the exposed electrode.

The second substrate 302 faces the first substrate 301. The liquid crystal layer 320 is disposed between the first and second substrates 301 and 302.

A buffer portion 312 is formed on the second substrate 302. The buffer portion 312 may be formed of various organic materials. The buffer portion 312 provides substantially a flat surface on the lower portion of the second substrate 302 so that the color filter 313 has substantially an even surface. In addition, the buffer portion 312 buffs stress applied to the liquid crystal display panel 300 so as to improve durability of the liquid crystal display panel 300.

The black matrix 314 is formed on the buffer portion 312 in a predetermined pattern. The black matrix 314 prevents the visible radiation realized by the color filter 313 from mixing with each other and interfering with each other, and blocks external light.

The color filter 313 is formed on the black matrix 314. The color filter 313 is also located on the buffer portion 312. The buffer portion 312 includes one or more via holes, and the color filter 313 is formed to fill the via holes in the buffer portion 312. Therefore, a height of the color filter 313 may be adjusted, and a coupling force between the color filter 313 and the second substrate 302 may be improved.

A second electrode 310 is formed on a lower surface of the color filter 313, and the liquid crystal layer 320 is disposed between the first and second electrodes 309 and 310.

The spacer 311 is disposed between the first and second electrodes 309 and 310, and the spacer 311 maintains the space in which the liquid crystal layer 320 is disposed.

On the other hand, the sealing member 316 is disposed on the outer portion of the liquid crystal layer 320 so that the first and second substrates 301 and 302 are coupled to each other. The sealing member 316 may be a UV-curable resin.

The protrusion members 317 are disposed so as to at least partially overlap with the sealing member 316. In more detail, the protrusion members 317 are formed on the second substrate 302. That is, the protrusion members 317 are formed on the same layer as that of the buffer portion 312, and may include the same material as that of the buffer portion 312. The protrusion members 317 are separated from each other.

The reflective layer 318 is formed on the protrusion members 317. The reflective layer 318 is formed to cover surfaces of the protrusion members 317. The reflective layer 318 includes a metal material, for example, the same material as that of the black matrix 314.

The cover layer 319 is also formed on the reflective layer 318. The cover layer 319 contacts the sealing member 316. The cover layer 319 is formed to fill spaces between the protrusion members 317. The cover layer 319 prevents the plurality of protrusion members 317 and the cover layer 319 from being damaged.

In addition, a surface of the cover layer 319, which contacts the sealing member 316, is formed flat so that the coupling force between the cover layer 319 and the sealing member 316 may be improved.

The cover layer 319 may be formed of various materials, for example, the same material as that of the color filter 313.

A wiring portion 315 is formed on the first substrate 301 so as to contact the sealing ember 316. The wiring portion 315 includes a plurality of wires that are separated from each other. In addition, although not shown in FIG. 5, the wiring portion 315 is electrically connected to the electrode of the thin film transistor, that is, the gate electrode 303, the source electrode 306, or the drain electrode 307.

The liquid crystal display panel 300 includes the protrusion members 317. In addition, the reflective layer 318 is formed on the protrusion members 317. During fabricating the liquid crystal display panel 300, the UV radiation incident through the first substrate 301 to cure the sealing member 316 are reflected by the reflective layer 318 toward the first substrate 301. Thus, the UV radiation may effectively reach the portion of the sealing member 316, which is adjacent to the wiring portion 315, and thus, the entire portion of the sealing member 316 may be substantially evenly cured.

Therefore, durability of the sealing member 316 is improved, and thereby improving the durability of the liquid crystal display panel 300.

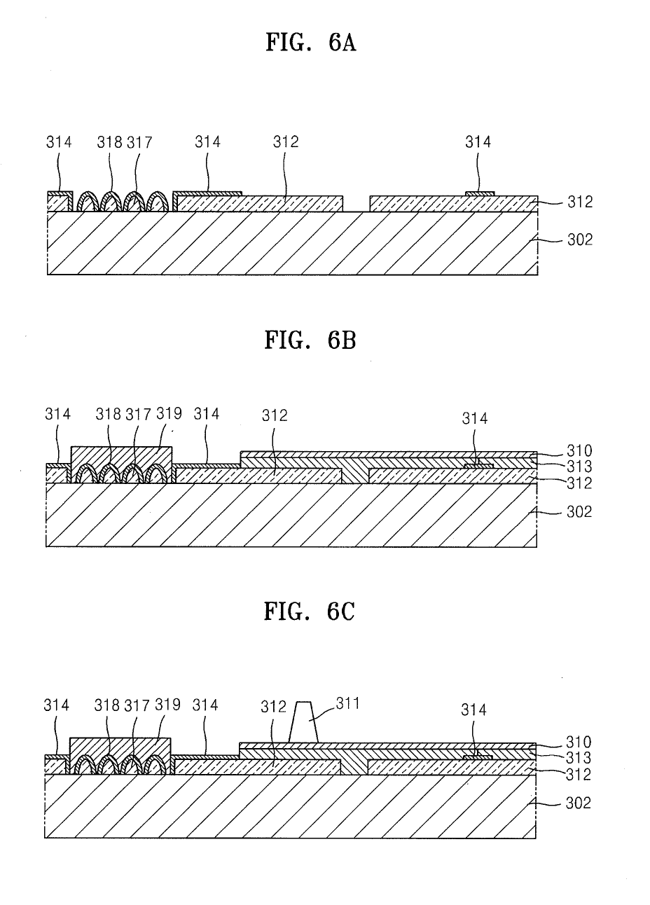

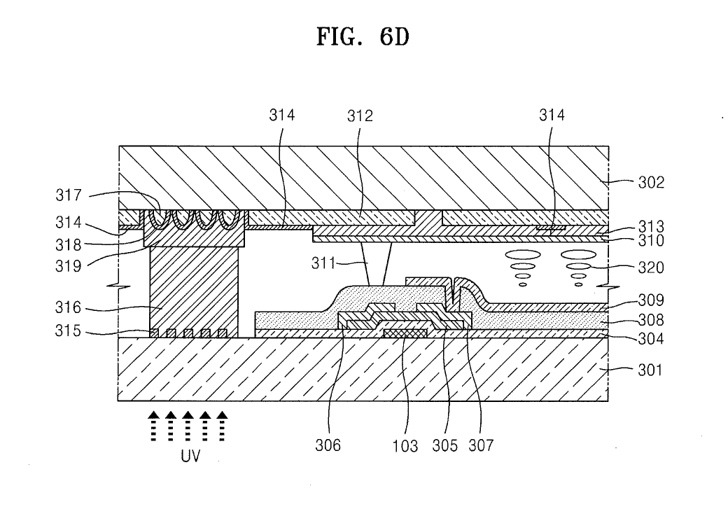

FIGS. 6A through 6D are cross-sectional views illustrating a method of fabricating the liquid crystal display panel 300 of FIG. 5 according to another embodiment.

Referring to FIG. 6A, the buffer portion 312, the protrusion members 317, the black matrix 314, and the reflective layer 318 are formed on the second substrate 302. The black matrix 314 is formed on the buffer portion 312 in a predetermined pattern. The reflective layer 318 is formed on the protrusion members 317. The reflective layer 318 may be formed substantially simultaneously with the black matrix 314, and formed of the same material as that of the black matrix 314. The buffer portion 312 includes one or more via holes.

After that, referring to FIG. 6B, the cover layer 319, the color filter 313, and the second electrode 310 are formed. The color filter 313 is formed on the black matrix 314 to fill the via holes formed in the buffer portion 312. The second electrode 310 is formed on the color filter 313. The second electrode 310 may include a transparent conductive material such as ITO. The cover layer 319 is formed on the reflective layer 318 to fill spaces between the protrusion members 317, and has a flat surface. The cover layer 319 may be formed of the same material as that of the color filter 313. In more detail, the color filter 313 includes various filters corresponding to various colors, and the cover layer 319 may be formed of the same material as that included in one of the filters.

Referring to FIG. 6C, the spacer 311 is formed on the second electrode 310. The spacer 311 is formed of an insulating material.

Referring to FIG. 6D, the sealing member 316 is formed between the first and second substrates 301 and 302, and the UV radiation is irradiated thereto. Then, the liquid crystal display panel 300 of FIG. 5 is fabricated. The UV radiation is irradiated from a side of the first substrate 301 toward the second substrate 302 in order to cure the sealing member 316. In addition, the UV radiation reaching the protrusion members 317 and the reflective layer 318 after transmitting through the sealing member 316 are reflected back toward the first substrate 301. Therefore, the entire portion of the sealing member 316 may be cured evenly.

According to at least one of the disclosed embodiments, the durability of the liquid crystal display panel may be easily improved.

While the disclosed embodiments have been particularly shown and described with reference to the accompanying drawings, it will be understood by those of ordinary skill in the art that various changes in form and details may be made therein without departing from the spirit and scope of the following claims.

What is claimed is:

1. A liquid crystal display panel comprising:
a first substrate and a second substrate facing each other;
a liquid crystal layer disposed between the first and second substrates;
a color filter disposed between the liquid crystal layer and the second substrate;
a black matrix formed on the color filter;
a sealing member disposed on an outer portion of the liquid crystal layer between the first and second substrates so as to couple the first and second substrates to each other;
a plurality of protrusion members formed on the second substrate so as to at least partially overlap with the sealing member;
a reflective layer formed on the protrusion members; and
a cover layer formed on the reflective layer so as to cover the reflective layer and the protrusion members.

2. The liquid crystal display panel of claim 1, further comprising a wiring portion formed between the sealing member and the first substrate.

3. The liquid crystal display panel of claim 2, further comprising a thin film transistor disposed between the first substrate and the liquid crystal layer so as to be electrically connected to the wiring portion, wherein the thin film transistor comprises a gate electrode, an active layer, a source electrode, and a drain electrode.

4. The liquid crystal display panel of claim 1, wherein the cover layer fills spaces between the protrusion members.

5. The liquid crystal display panel of claim 1, wherein the cover layer is formed between the sealing member and the reflective layer.

6. The liquid crystal display panel of claim 1, wherein a surface of the cover layer, which contacts the sealing member, is formed substantially flat.

7. The liquid crystal display panel of claim 1, further comprising a buffer portion between the second substrate and the color filter.

8. The liquid crystal display panel of claim 7, wherein the buffer portion is formed on the second substrate so as to be separated from the protrusion members.

9. The liquid crystal display panel of claim 7, wherein the buffer portion is formed of the same material as that of the protrusion members.

10. The liquid crystal display panel of claim 7, wherein the buffer portion comprises one or more via holes, and wherein the color filter is formed to fill the via holes.

11. The liquid crystal display panel of claim 1, wherein the reflective layer is formed of the same material as that of the black matrix.

12. The liquid crystal display panel of claim 1, further comprising a spacer disposed between the first and second substrates so as to maintain a space in which the liquid crystal layer is disposed,
wherein the cover layer is formed of the same material as that of the spacer.

13. The liquid crystal display panel of claim 1, wherein the cover layer is elongated so as to cover the color filter and the black matrix.

14. The liquid crystal display panel of claim 1, wherein the cover layer is formed of the same material as that of the color filter.

15. A method of fabricating a liquid crystal display panel, the method comprising:
preparing a first substrate and a second substrate which face each other;
disposing a liquid crystal layer between the first and second substrates;
disposing a black matrix between the liquid crystal layer and the second substrate;
disposing a color filter on the black matrix;
disposing a sealing member on an outer portion of the liquid crystal layer between the first and second substrates;
forming a plurality of protrusion members on the second substrate so as to at least partially overlap with the sealing member;
forming a reflective layer on the protrusion members;
forming a cover layer on the reflective layer so as to cover the reflective layer and the protrusion members; and
irradiating ultraviolet (UV) radiation onto the sealing member so as to couple the first and second substrates to each other.

16. The method of claim 15, further comprising forming a wiring portion between the sealing member and the first substrate.

17. The method of claim 15, wherein the UV radiation is irradiated from a side of the first substrate toward the second substrate.

18. The method of claim 15, wherein the UV radiation transmitting through the sealing member is reflected by the reflective layer.
